(19) United States
(12) Patent Application Publication
(10) Pub. No.: US 2003/0224799 A1
(43) Pub. Date: Dec. 4, 2003

(54) Facilitating data transfers with mobile entities via wireless communication hotspots

(76) Inventors: Robert Francis Squibbs, Bristol (GB); James Thomas Edward McDonnell, Malmesbury (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/395,881

(22) Filed: Mar. 25, 2003

(30) Foreign Application Priority Data
Mar. 26, 2002 (GB) 0207040.7

(51) Int. Cl. H04Q 7/20

(52) U.S. Cl. 455/450; 455/449

(57) ABSTRACT

A mobile device includes a communications subsystem by which data can be sent/received via the wireless-based communications infrastructures of localized communication hotspots traversed by the mobile device. To facilitate such transfers, the predicted track of the mobile device is used to determine what hotspots are likely to be traversed by the device. Communication resources of these hotspots are then managed to ensure that the device has appropriate utilization rights and/or bandwidth reservations for its data transfer needs.

### FIELD OF THE INVENTION

The present invention relates to the management of communication resources for facilitating, data transfers with mobile entities via wireless-based communication hotspots.

### BACKGROUND OF THE INVENTION

Wireless LANs are gaining substantial acceptance as a means for providing connectivity over a restricted area to mobile devices. Whilst there are a number of different wireless LAN architectures and the present invention is not limited to any particular one (or, indeed to wireless LANs), the following description is generally written using the terminology applied in the ANSI/IEEE Standard 802.11 (“Wireless LAN Medium Access Control and Physical Layer Specifications”). More particularly, FIG. 1 of the accompanying drawings illustrates the main components of a wireless LAN using that terminology. Thus, a typical wireless LAN 5 comprises a distribution system 10 that serves to interconnect a number of access points (AP) 11 via a network. Each access point 11 connects with mobile stations (MS) 12 over a wireless medium to form a Basic Service Set 13 (BSS1 and BSS2). The totality of the basis service sets and the network that interconnects them is called an Extended Service Set (ESS). The wireless LAN may connect with other networks via a portal 14.

Wireless LANs can be used to provide connectivity over limited areas such as public spaces and publicly-accessible premises, both commercial and noncommercial. These limited areas of connectivity are often referred to as “hotspots” as they generally provide a much higher speed of data transfer to mobile devices than is available via other wireless systems of more general coverage such as the data-capable bearer services provided by cellular radio networks such as GSM.

Whilst such connectivity “hotspots” are presently provided primarily by wireless LANs, other technologies can also be used to provide localised areas of high transfer rates (as compared to the surrounding environment) and as used herein the term “hotspot” is intended to be technology independent, merely indicating that improved data transfer rates are available in localised areas. An example of an alternative technology that can be used to provide a communications hotspot is a system that tracks the movement of a mobile device whilst within a limited range and uses a directional antenna pointing at the device to provide a high data rate link. Another example is the use of a cluster of infrared transceivers within a limited area, adjacent transceivers operating at different frequencies or with different modulations to avoid interference.

A significant drawback to the use of communication hotspots for transferring substantial amounts of data to mobile entities moving through the hotspots is that the dwell time of the entities in any hotspot is limited; in addition, a mobile entity may well not have access rights to use all hotspots through which it passes and even if it has, there may be no available capacity at the time the device is within the hotspot.

It is an object of the present invention to facilitate data transfer to/from mobile entities as they traverse communication hotspots.

### SUMMARY OF THE INVENTION

According to one aspect of the present invention, there is provided a method of managing communication resources in relation to the transfer of data to/from a mobile entity using wireless-based communications infrastructures of multiple localized communication hotspots traversed by the mobile entity, at least some of the hotspots requiring separate utilization rights to each other, the method comprising the steps of,

(a) predicting progress of the mobile entity;

(b) based on the predicted progress of the mobile entity and its data transfer needs, making a determination about possible desired future utilization by the mobile entity of the communications infrastructure of a particular said hotspot likely to be traversed by the entity; and

(c) in dependence on said determination, obtaining, in advance, utilisation rights for the mobile entity to use said particular hotspot when traversing it.

According to another aspect of the present invention, there is provided a service system for managing communication resources in relation to the transfer of data to/from a mobile entity using wireless-based communications infrastructure of multiple localized communication hotspots traversed by the mobile entity, at least some of the hotspots requiring separate utilization rights to each other, the system comprising:

a first communications subsystem for communicating with the mobile entity;

a second communications subsystem for communicating with the communications infrastructure of said hotspots;

a utilization determination subsystem operative to predict progress of the mobile entity relative to said at least one hotspot, and to make a determination, based on the predicted progress of the mobile entity and its data transfer needs, about possible desired future utilization by the mobile entity of the communications infrastructure of a particular said hotspot likely to be traversed by the entity; and

a management subsystem operative in dependence on said determination, to obtain, in advance, utilisation rights for the mobile entity to use said particular hotspot when the mobile entity comes to traverse that hotspot.

According to a further aspect of the present invention, there is provided a mobile entity comprising:

a communications subsystem for communicating with wireless-based communication infrastructure of localized communication hotspots in order to transfer data to/from the mobile entity;

a utilization determination subsystem operative to predict progress of the mobile entity relative to said at least one hotspot, and to make a determination, based on the predicted progress of the mobile entity and its data transfer needs, about possible desired future utilization by the mobile entity of the communications infrastructure of a particular hotspot likely to be traversed by the entity; and

a management subsystem operative in dependence on said determination, to obtain, in advance, utilisation rights for the mobile entity to use said particular hotspot when the mobile entity comes to traverse that hotspot.

An additional aspect of the invention relates to a computer arrangement for managing communication resources in relation to the transfer of data to/from a mobile entity having wireless-based communications infrastructures of multiple localized communication hotspots traversed by the mobile entity, at least some of the hotspots requiring separate utilization rights to each other, the computer arrangement comprising a processor and a memory for:

(a) deriving a first signal indicative of a prediction of progress of the mobile entity;

(b) deriving a second signal indicative of a possible desired future utilization by the mobile entity of the communications infrastructure of a particular hotspot likely to be traversed by the entity in response to the first signal; and

(c) deriving a third signal indicative of utilisation rights for the mobile entity to use said particular hotspot when traversing it in response to said second signal, the processor and memory being arranged to derive the third signal in advance of the mobile entity entering the particular hotspot.

An added aspect of the invention relates to a memory storing a program for enabling a computer arrangement to manage communication resources in relation to the transfer of data to/from a mobile entity having wireless-based communications infrastructures of multiple localized communication hotspots traversed by the mobile entity, at least some of the hotspots requiring separate utilization rights to each other, the memory being programmed for causing the computer arrangement to:

(a) predict progress of the mobile entity;

(b) based on the predicted progress of the mobile entity and its data transfer needs, determine possible desired future utilization by the mobile entity of the communications infrastructure of a particular hotspot likely to be traversed by the entity; and

(c) in dependence on said determination, obtain, in advance, utilisation rights for the mobile entity to use said particular hotspot when traversing it.

### BRIEF DESCRIPTION OF THE DRAWINGS

Embodiments of the invention will now be described, by way of non-limiting example, with reference to the accompanying diagrammatic drawings, in which:

FIG. 1 is a diagram of a known wireless LAN architecture;

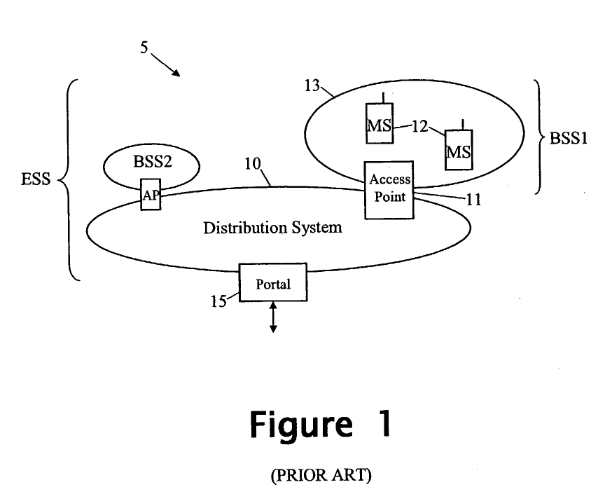

FIG. 2 is a diagram of a resource-management service system, embodying the invention, for determining future hotspot utilization needs of mobile devices and for managing communication resources accordingly; and

FIG. 3 is a flow chain showing a decision process carried out by the resource management service system of FIG. 2.

### BEST MODE OF CARRYING OUT THE INVENTION

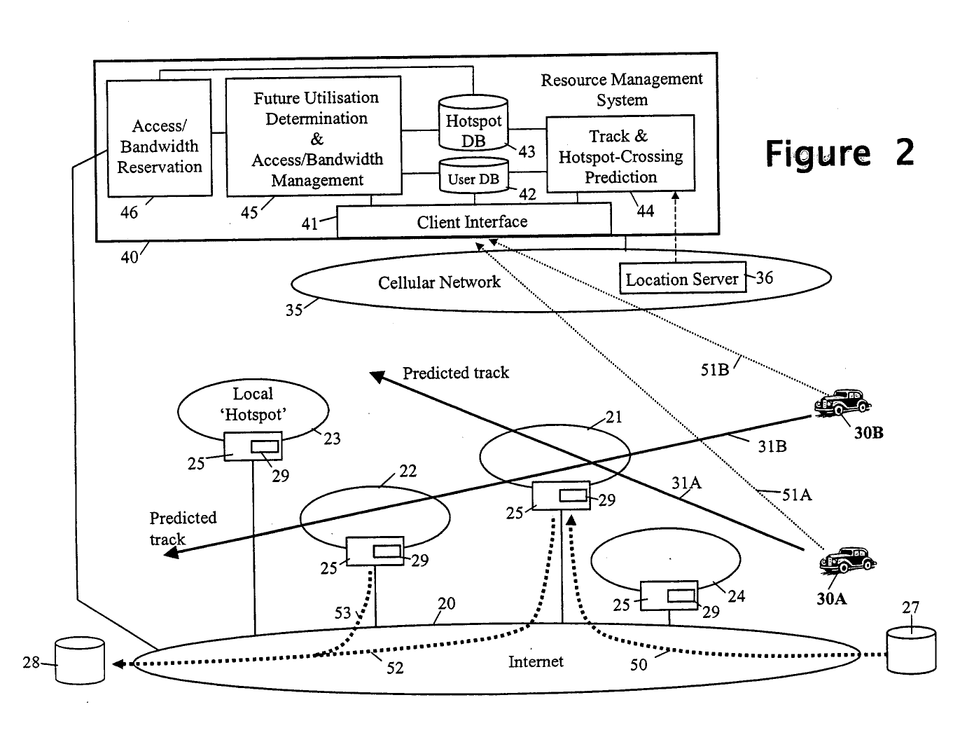

FIG. 2 shows a plurality of wireless communication hotspots 21 to 24 each formed, for example, by a wireless LAN infrastructure 25 having a limited coverage area within which suitably equipped and authorised mobile devices 30A, 30B (here depicted as vehicle borne) can establish wireless communication with the infrastructure. Each hotspot infrastructure 25 includes a portal providing connectivity to the public internet 20 (or other wide-area data network) and its connected resources 27, 28 (typically, respectively content sources and sinks); as a result, a mobile device 30A, 30B traversing a hotspot can connect to and exchange data with the internet-connected resources 27, 28. The communications technology employed by the hotspots may vary from one hotspot to another.

In the present case each hotspot 21-24 is independently managed and its infrastructure 25 includes a control subsystem 29 with mechanisms, known per se, for restricting usage to authorised mobile devices. Thus, separate utilisation rights are required by a mobile entity to utilize each other. Furthermore, as used herein, reference to a mobile entity having utilisation rights for a particular hotspot does not mean that the mobile entity will necessarily be able to use the hotspot at any particular moment as the resources of the hotspot might be occupied in servicing other entities; however, as will be described below, a mobile entity can reserve (or have reserved for it) communication resources to permit it to communicate at at least a particular data rate.

Thus, in the present embodiment, the control subsystem 29 of each hotspot also includes allocation mechanisms enabling a suitable-embodied mobile device to connect through to the Internet at any selected one of several different data rates (connection speeds) with the resources needed for the selected data rate being made available on a guaranteed basis, at least so far as the resources of the hotspot infrastructure are concerned. In addition, in the present embodiment the control subsystem 29 further includes reservation mechanisms enabling hotspot resources for a particular data rate to be reserved in advance. For convenience, the allocation and reservation of the hotspot resources to provide for a particular data transfer rate, is referred to below as “bandwidth” allocation and reservation.

A resource-management service system 40 communicates with the hotspot infrastructures via the Internet 20 (or any other appropriate channel) to set up hotspot utilization rights and/or reserve bandwidth (transfer data rate) for mobile devices that are registered users of the service system 40 and have a need to use the hotspot communication resources; in the present case, both mobile devices 30A and 30B are registered users. While resource management service system 40 is illustrated as including several individual subsystems (i.e., client interface 41, track and hotspot-crossing prediction unit 44, future utilisation determination/bandwidth management processing unit 45 and access/bandwidth reservation unit 46, as well as memories labeled as user data base 42 and hotspot data base 43) it is to be understood that these subsystems and memories can be incorporated into a programmed digital computer or processor having a memory storing a (1) program for controlling the subsystems and (2) the data bases.

In the present embodiment, the mobile devices 30A, 30B communicate with the service system 40 via a data-capable bearer service of a cellular radio network 35 such as a GSM based PLMN (Public Land Mobile Network) that provides ubiquitous coverage over an area encompassing all the hotspots 21-24.

The service system 40 is arranged to receive information about the movement of each registered mobile device 30A,B and of its data transfer needs. Based on predictions of what hotspots the mobile devices are likely to traverse, the service system 40 sets up hotspot utilization rights and/or reserves hotspot bandwidth in order to enable the mobile devices to effect the data transfers via the hotspots they traverse on their respective routes. The service system 40 can reserve hotspot utilization and bandwidth for a mobile device prior to the start of data transfer and whilst the device is outside any hotspot. The service system 40 can also determine that a current data transfer is unlikely to be completed during traversal of the hotspot in which the mobile device is currently located; in this case, the service system can either seek to increase the available bandwidth for the data transfer so as to complete it in the current hotspot, or set up utilization rights and/or reserve bandwidth for the mobile device in a next hotspot to be traversed by the device.

A more detailed description of the operation of the service system 40 is given below in respect of example data transfers undertaken by the mobile devices 30A,B.

Considering first mobile device 30A, it is assumed that this device has determined that it wishes to download a large content file from a content server 27—how this determination is made is not relevant for present purposes but may be as a result of browsing the Internet via a data-capable bearer service of the cellular network or on the basis of a predetermined transfer schedule (for example, all new emails are to be downloaded together every hour). Upon determining that a large file is to be downloaded, the mobile device establishes communication with the service system 40 via the cellular network 35 where a client interface 41 first checks with user database 42 that the mobile device is (or belongs to) a registered user of the service system. Location server 36 determines and derives signals indicative of location fixes giving the location of the mobile device 30, which signals are passed to a track and hotspot-crossing prediction unit 44 of the service system. Location server 36 derives the device location signals in a standard manner from measurements taken by the cellular network infrastructure. Alternatively, the mobile device 30 derives the location fix indicating signals in response to signals from an associated GPS system or from the location server 36.

The prediction unit 44 uses the received location fixes to predict the progress of the mobile device 30A and, in particular, to derive a signal indicative of a prediction of the traversal of device 30A of hotspots known to the service system; data about these hotspots, including geographical coverage data, are stored as signals in database 43. Unit 44 can simply work on a straight-line extrapolation of the current direction of travel and speed of the mobile device (derived from successive location fixes) to determine and derive a signal indicative of the intersection of the predicted track of the device with hotspot coverage areas. Alternatively, more sophisticated approaches can be used taking account, for example, of route constraints such as would apply to vehicles (i.e. they must follow roads) where it is known or deduced that the mobile is vehicle bone. Use can also be made of histories of previous routes followed by the mobile device 30A (for example, user database 42 can store signals indicative of frequently followed routes and then seek to correlate the observed track of the mobile device 30A with such a route in order to predict the future track of the mobile device). Of course, information on the route being followed can also be uploaded from the mobile device 30 to the service system 40.

On the basis of the predicted programs of the mobile device 30 and the geographic extent of a hotspot in which the mobile device is already located, the prediction unit 44 is further arranged to determine and derive a signal indicative of the length of time that the device is likely to remain within the coverage of the hotspot.

In present example, upon unit 44 determining that the mobile device 30A is likely to traverse one or more hotspots, unit 44 derives a signal indicative of this fact and the size of the file that the device 30A wishes to download; unit 44 supplies the signal to processing unit 45 via control functionality of the client interface 41. Unit 45 also is responsive to signals indicative of the capabilities of the mobile device 30A either directly from the device itself or from user database 42.

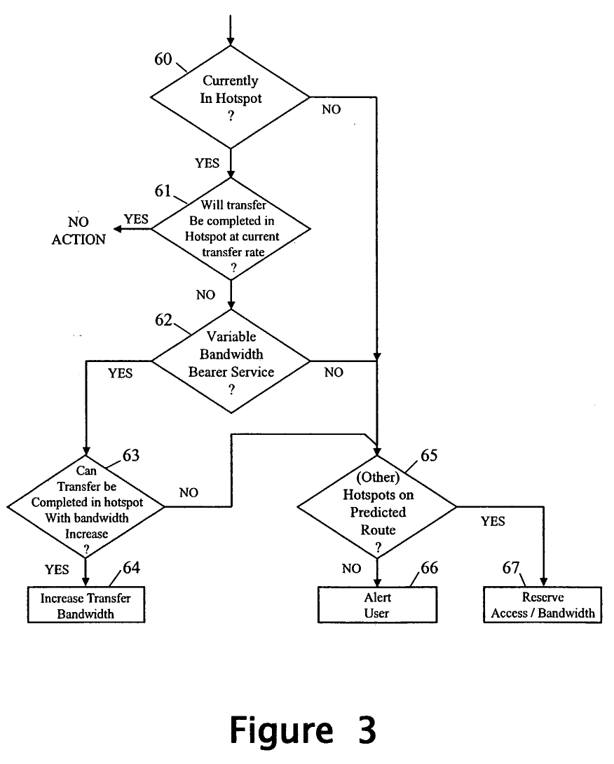

The processing unit 45 is operative then to make determinations and derive signals indicative of future utilisation of hotspot resources for satisfying the data transfer needs of the mobile device. FIG. 3 is a flow chart illustrating the general process carried out by the unit 45 for this purpose. More particularly, the unit 45 first determines whether the mobile device is currently in a hotspot and transferring data (block 60); if, as in the present example, this is not the case, the unit 45 checks the information it has received from unit 44 to see if the mobile device is likely to pass through a hotspot in the future (block 65). If the mobile device 30A is not predicted to pass through a hotspot, the unit 45 causes an alert to be sent to the mobile device 30A (block 66) to warn the device user of this to enable the latter to make a decision as to what alternative action to take (for example, to accept download of the file via a data-capable bearer service of the cellular network 35, the device having been set up with a default in which such an option is only permitted for files over a certain size with user permission, automatic download only being permitted via hotspots under the organisation of the service system 40).

In response to unit 45 determining that the mobile device 30A is predicted to traverse at least one hotspot 21-24 along its route (in this case, hotspot 21; see predicted track 31A in FIG. 2), unit 45 (during operation 67) instructs reservation unit 46 to make appropriate utilization rights/bandwidth reservations with the relevant hotspot. In particular, unit 45 supplies a signal to unit 46 indicative of the identity of the mobile device 30A, the (next) hotspot to be traversed by the device, the likely time of entry of the device into the hotspot, and the data transfer rate that is to be provided. Unit 45 determines the data transfer rate on the basis of the capabilities of the device, the costs associated with various different transfer rates, and the amount of data to be transferred, it being appreciated that a significantly higher cost is generally be considered acceptable if the data transfer can be completed during the traversal of a single hotspot.

The reservation unit 46 then supplies the control subsystem 29 of the relevant hotspot 21 with a signal commanding that control subsystem to set up, in advance, utilization rights for the mobile device 30A and to reserve resources to enable the device to connect to the Internet at a particular data rate. This reservation is done on the basis of the predicted time of entry of the mobile device into the coverage area of the hotspot; entry within a small margin of that time guaranteeing that the resources are available immediately whereas entry at later or earlier times only guaranteeing that the resources will be available within a certain time delay.

When unit 46 has made the requested reservation, the unit 46 sends a signal back to unit 45; the signal unit 46 passes to unit 45 is a signal that is a utilization pass-code specified by the hotspot control subsystem. The unit 46 then supplies a signal to the mobile device 30A, via the client interface 41, indicative of the hotspot utilization that has been set up and any pass-code to be used. If the unit 46 is unable to make the desired hotspot resource reservation, the unit 46 is arranged either to negotiate the closest suitable reservation with the hotspot concerned, or else to report back to the unit 45 which modifies its reservation requirements.

In due course, the mobile device 30A starts to traverse the hotspot 21 and in doing so seeks to gain access to the communication resources of the hotspot in order to establish communication with the content server 27 to effect the desired download. In the present example, it is assumed that the download is successfully established and completed during the traversal of hotspot 21 by the mobile device 30A.

It will be appreciated that track prediction is not necessarily done on a once-off basis and can, instead, be done repeatedly as each new location fix becomes available or at some other suitable frequency. In this case, the prediction of hotspot crossing and time of arrival at a hotspot can be successively refined and used by the units 45 and 46 to modify the utilization rights and bandwidth reservations made for the hotspot resources. In addition, the data transfer requirements of the mobile device 30A, B frequently change with time to cause changes in the hotspot utilization and bandwidth reservations.

This updating of track prediction and data transfer needs can go on not only as the mobile device 30A progresses towards a hotspot, but also during the data transfer process once the mobile device has entered a hotspot coverage area and initiated a data transfer. In this case, as already mentioned above, the unit 44 is arranged to determine the time remaining in the hotspot based on a predicted track. Now when the unit 45 runs the FIG. 3 process, since the device 30A is within a hotspot and effecting a data transfer, unit 45 exits block 60 to block 61 where it determines whether, having regard to the remaining time in the hotspot for the device, there is sufficient time to complete the data transfer at the current data rate; if this is the case, unit 45 takes no action, whereas if there is insufficient time to complete the transfer, the unit 45 goes on to check (block 62) whether a different (higher) data transfer rate (transfer bandwidth) can be set. If this is not the case, the unit 45 proceeds to block 65 where it checks to see if other hotspots are on the predicted track of the mobile device, as already described above. If, however, unit 45 determines during block 62 that a higher data transfer rate can be set, then unit 45 determines during operation 63 as to whether the higher transfer rate would result in completion of the data transfer. If operation 63 determines this is so, unit 45 increases the data transfer rate (step 64), whereas otherwise the unit proceeds to block 65.

Increasing the data transfer rate may be something that lies within control of the mobile device 30A without the need for the service system to contact the control subsystem 29 of the hotspot concerned (hotspot 21 in the present example); in this case, the service system 40 simply supplies a signal to the mobile device that device 30A should go to a higher transfer rate and the device proceeds to do so in cooperation with the infrastructure of the hotspot. However, in order to achieve a higher data transfer rate, unit 45 supplies to unit 46 a signal commanding unit 46 to contact the control subsystem of the hotspot to set up the increased transfer rate.

As regards the mobile device 30B shown in FIG. 2, this mobile device is shown as having a predicted track 31B that takes it through two hotspots 21 and 22. In this example, it is assumed that the mobile device 30B wishes to upload a data file to a content sink 28 starting at a particular time. Either at this scheduled upload time or a short while beforehand, the mobile device 30B contacts the service system 40 to set up the transfer via the hotspots to be traversed by the device. The service system 40 then carries out the steps already described to set up transfer via the hotspot 21. In due course, the mobile device 30B enters the coverage area of hotspot 21 and initiates data upload. As the mobile device 30B traverses the hotspot 21, further determinations made by the service system 40 as to the hotspot utilisation requirements of the device indicate that the data upload will not be completed during the current traversal of hotspot 21, either at the current data transfer rate or at any available higher rate. The service system 40 then proceeds to determine that the device 30B is also likely to traverse hotspot 24 and accordingly makes utilization and bandwidth reservations with that hotspot for completion of the data transfer. If the hotspot control subsystem 29 needs to know how much data is to be transferred, then the unit 45 makes a prediction based on the amount of data remaining to be transferred and the predicted time remaining in hotspot 21.

Rather than the unit 45 operating on the basis of only making reservations for one hotspot ahead of the current position of the mobile device, unit 45 can be arranged to reserve resources in all hotspots predicted to be traversed by the mobile device and needed to complete a particular data transfer. Thus, prior to the mobile device 30B entering hotspot 21, the unit 45 can be arranged to reserve utilization and bandwidth in both hotspots 21 and 22.

Where a data transfer is interrupted by a mobile device leaving a hotspot, then the endpoints of the transfer use any suitable mechanism enabling the transfer to be subsequently resulted at the point where it was interrupted; such mechanisms are currently widely used for Internet downloads particularly for users using unreliable, low data rate, access connections.

It will be appreciated that many variants are possible to the above-described embodiments of the invention. For example, the reservation unit 46 can be arranged to make utilization and/or bandwidth reservations on the basis of the needs of all devices currently using the service system. Thus, utilization and bandwidth are not reserved for particular devices but as a whole for all registered devices. The reservations made are preferably not just an aggregate of the individual device needs but, instead, take account on a statistical basis of the actual usage needs likely to result from the predictions. Thus, utilization rights may be reserved for only 90% of the mobile devices predicted as likely to traverse a particular hotspot because statistically it had been found that only in exceptional circumstances did more than 90% of those devices actually do enter the hotspot with an unsatisfied data transfer need. It will be appreciated that such a statistical-weighting reservation mechanism preferably takes account of the likelihood of a device keeping to its predicted track and a simple measure that can be used in this case is the distance of the device from the hotspot—the greater the distance, the greater the possibility of the device changing direction and not traversing the hotspot. Thus, if all devices predicted as having a future utilization need for a hotspot are near to entering the hotspot, then the statistical-weighting reservation mechanism should reserve nearly 100% of the resources predicted as being needed; in contrast, where the mobile devices are all at some distance from the hotspot, then the statistical-weighting reservation mechanism can be arranged to reserve, for example, only 80% of the resources predicted as necessary.

Although in the above-described embodiment, the mobile devices use an ubiquitous communications system (for example, cellular network 35) to communicate with the service system, it is alternatively possible simply to use the connectivity provided by the hotspots assuming that the mobile devices have at least low data rate utilization rights to these hotspots for connecting through them to the service system 40. In this case, it can be useful to arrange for the content sources/sinks 27, 28 to inform the service system whenever a data transfer is interrupted before its completion, the service system then having a positive indication that the mobile device has exited a hotspot. It is alternatively possible to arrange for the hotspot control system itself to monitor data transfer progress and indicate to the service system when an incomplete transfer is interrupted.

Where a mobile device has connectivity to an ubiquitous communications service such as provided by a data-capable bearer service of a cellular radio network 35, then this service can be used to continue a data transfer between hotspots, the data transfer being handed over from a hotspot connection to the bearer service as the mobile device leaves the hotspot and being handed over again to the next hotspot connection when established.

The functionality of the service system (other than the predicted-utilization aggregation and statistical-weighting mechanisms mentioned above) can be incorporated into a mobile device so that the device itself takes care of reserving the resources it predicts that it will need in the future.

It will be appreciated that two or more hotspots can be jointly managed on the basis that the right to utilize one of the hotspots is also a right to utilize the other hotspots that are under the same management so that utilization rights for these jointly-managed hotspots need only be obtained once. Furthermore, a hotspot may not have any provision for allocating bandwidth and simply controls utilization; in this case, it is only required to obtain utilization rights to the hotspot.

Although in the above-described embodiment the remote entity with which the mobile device 30 is in communication is an internet-connected resource, it is to be understood that the remote entity could be connected directly to the communications infrastructure of a hotspot or connected to any other communications system accessible via the hotspot(s).

1. A method of managing communication resources in relation to the transfer of data to/from a mobile entity using wireless-based communications infrastructures of multiple localized communication hotspots traversed by the mobile entity, at least some of the hotspots requiring separate utilization rights to each other, the method comprising the steps of:
(a) predicting progress of the mobile entity;
(b) based on the predicted progress of the mobile entity and its data transfer needs, making a determination about possible desired future utilization by the mobile entity of the communications infrastructure of a particular said hotspot likely to be traversed by the entity; and
(c) in dependence on said determination, obtaining, in advance, utilisation rights for the mobile entity to use said particular hotspot when traversing it.

2. A method according to claim 1, wherein step (c) further includes reserving resources of the communications infrastructure of said particular hotspot sufficient to enable the mobile entity to effect data transfer at least at a particular data transfer rate when the mobile entity comes to traverse that hotspot.

3. A method according to claim 1, wherein the determination effected in step (b) is made during the course of a data transfer that is being effected as the mobile entity traverses a said hotspot other than said particular hotspot, said determination first determining that the data transfer will not be complete before the current hotspot is exited.

4. A method according to claim 1, wherein the determination effected in step (b) is made whilst the mobile entity is not within a said hotspot.

5. A method according to claim 1, wherein at least steps (b) and (c) are carried out by a service system with which the mobile entity is in communication via a cellular radio network independently of whether or not the mobile entity is in a hotspot.

6. A method according to claim 1, wherein at least steps (b) and (c) are carried out by a service system with which the mobile entity is in communication via the communication infrastructure of hotspots traversed by the mobile entity.

7. A method according to claim 1, wherein at least steps (b) and (c) are carried out by a service system with which the mobile entity can communicate at least intermittently, the service system carrying out step-(b) for a plurality of such mobile entities, and step (c) involving statistically weighting the future hotspot-utilisation needs of the mobile entities and making corresponding arrangements with the hotspot communication infrastructure.

8. A method according to claim 1, wherein at least steps (b) and (c) are carried out by a service system with which the mobile entity can communicate at least intermittently, the service system carrying out steps (b) and (c) for a plurality of such mobile entities and step (c) including making arrangements with the hotspot communication infrastructure specific to each said mobile entity.

9. A method according to claim 1, wherein at least steps (b) and (c) are carried out by the mobile entity, step (c) including communicating with the communications infrastructure of said particular hotspot to make said arrangements concerning use of the hotspot by the mobile entity.

10. A method according to claim I, wherein at least some of the hotspots use different communication techniques to other ones of said hotspots.

11. A method according to claim 3, wherein step (b) includes determining the time available for data transfer in a current hotspot based on a predicted route and speed of the mobile entity and hotspot coverage information, and determining the time required to effect a desired data transfer at a current or standard data transfer rate, comparison of said time available and said time required being used to indicate whether step (c) is to be carried out to enable the data transfer to be fully effected.

12. A method according to claim 1, wherein a data transfer only partially completed in a traversed hotspot is automatically resumed upon the mobile entity entering the said particular hotspot in respect of which arrangement for use by the mobile entity were made.

13. A method according to claim 1, wherein between hotspots said data transfer is continued using a data bearer service provided by a cellular radio infrastructure.

14. A service system for managing communication resources in relation to the transfer of data to/from a mobile entity using wireless-based communications infrastructure of multiple localized communication hotspots traversed by the mobile entity, at least some of the hotspots requiring separate utilization rights to each other, the system comprising:
a first communications subsystem for communicating with the mobile entity;
a second communications subsystem for communicating with the communications infrastructure of said hotspots;
a utilization determination subsystem operative to predict progress of the mobile entity relative to said at least one hotspot, and to make a determination, based on the predicted progress of the mobile entity and its data transfer needs, about possible desired future utilization by the mobile entity of the communications infrastructure of a particular said hotspot likely to be traversed by the entity; and
a management subsystem operative in dependence on said determination, to obtain, in advance, utilisation rights for the mobile entity to use said particular hotspot when the mobile entity comes to traverse that hotspot.

15. A service system according to claim 14, wherein the management subsystem is further operative to reserve resources of the communications infrastructure of said particular hotspot sufficient to enable the mobile entity to effect data transfer at least at a particular data transfer rate when the mobile entity comes to traverse that hotspot.

16. A service system according to claim 14, wherein the utilisation determination subsystem is operative in respect of a data transfer currently being effected by the mobile entity using the communications infrastructure of a said hotspot in which the mobile entity is currently located, to determine whether the transfer is likely to be completed before the mobile entity leaves the hotspot and, where this is not the case, whether the mobile entity is predicted to traverse another hotspot, the management subsystem being adapted to be responsive to this determination indicating that the transfer is unlikely to be completed in the current hotspot but that the entity is predicted to traverse another hotspot, to treat said another hotspot as said particular hotspot and to obtain utilization rights for the mobile entity in respect thereof.

17. A service system according to claim 14, wherein the utilisation determination subsystem is operative in respect of a data transfer contemplated, but not yet started, by the mobile entity, to determine the next hotspot predicted to be traversed by the mobile entity, the management subsystem being adapted to be responsive to treat said next hotspot as said particular hotspot and to obtain utilization rights for the mobile entity in respect thereof.

18. A service system according to claim 14, wherein the first communications subsystem is a cellular radio subsystem for communicating with the mobile entity independently of the hotspot communications infrastructure.

19. A service system according to claim 14, wherein the service system is operative to make determinations for multiple mobile entities regarding future hotspot communications-infrastructure utilization needs of the entities, the management subsystem being operative to arrange utilization of said communications infrastructure based on a statistical weighting of the needs of said entities.

20. A mobile entity comprising:
a communications subsystem for communicating with wireless-based communication infrastructure of localized communication hotspots in order to transfer data to/from the mobile entity;
a utilization determination subsystem operative to predict progress of the mobile entity relative to said at least one hotspot, and to make a determination, based on the predicted progress of the mobile entity and its data transfer needs, about possible desired future utilization by the mobile entity of the communications infrastructure of a particular hotspot likely to be traversed by the entity; and
a management subsystem operative in dependence on said determination, to obtain, in advance, utilisation rights for the mobile entity to use said particular hotspot when the mobile entity comes to traverse that hotspot.

21. A mobile entity according to claim 20, wherein the management subsystem includes communication means additional to said communications subsystem for communicating directly or via a service system with the communication infrastructures of hotspots through which the entity is predicted to pass.

22. A mobile entity according to claim 20, wherein the management subsystem is further operative to reserve resources of the communications infrastructure of said particular hotspot sufficient to enable the mobile entity to effect data transfer at least at a particular data transfer rate when the mobile entity comes to traverse that hotspot.

23. A computer arrangement for managing communication resources in relation to the transfer of data to/from a mobile entity having wireless-based communications infrastructures of multiple localized communication hotspots traversed by the mobile entity, at least some of the hotspots requiring separate utilization rights to each other, the computer arrangement comprising a processor and a memory for:
(a) deriving a first signal indicative of a prediction of progress of the mobile entity;
(b) deriving a second signal indicative of a possible desired future utilization by the mobile entity of the communications infrastructure of a particular hotspot likely to be traversed by the entity in response to the first signal; and
(c) deriving a third signal indicative of utilisation rights for the mobile entity to use said particular hotspot when traversing it in response to said second signal, the processor and memory being arranged to derive the third signal in advance of the mobile entity entering the particular hotspot.

24. A memory storing a program for enabling a computer arrangement to manage communication resources in relation to the transfer of data to/from a mobile entity having wireless-based communications infrastructures of multiple localized communication hotspots traversed by the mobile entity, at least some of the hotspots requiring separate utilization rights to each other, the memory being programmed for causing the computer arrangement to:
(a) predict progress of the mobile entity;
(b) based on the predicted progress of the mobile entity and its data transfer needs, determine possible desired future utilization by the mobile entity of the communications infrastructure of a particular hotspot likely to be traversed by the entity; and
(c) in dependence on said determination, obtain, in advance, utilisation rights for the mobile entity to use said particular hotspot when traversing it.
